(19) United States
(12) Patent Application Publication
(10) Pub. No.: US 2026/0179229 A1
(43) Pub. Date: Jun. 25, 2026

(54) SYSTEMS AND METHODS FOR TRAINING A MODEL ESTIMATING A POLICY INVOLVING OBJECT MOTION USING DATA DIFFUSION

(71) Applicant: Toyota Research Institute, Inc., Los Altos, CA (US)

(72) Inventors: Jonathan A. DeCastro, Arlington, MA (US); Emily Sarah Sumner, Cambridge, MA (US); Deepak Edakkattil Gopinath, Washington, DC (US); Andrew Michael Silva, Cambridge, MA (US); Thomas M. Balch, Damariscotta, ME (US); Xiongyi Cui, Somerville, MA (US); Guy Rosman, Cambridge, MA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/989,541

(22) Filed: Dec. 20, 2024

(51) Int. Cl. G06T 7/20

(52) U.S. Cl. CPC G06T 7/20; G06T 2207/20081; G06T 2207/20084; G06T 2207/30241; G06T 2207/30252

(57) ABSTRACT

Systems, methods, and other embodiments described herein relate to estimating a policy for object motion by training a multi-modal model using diffusion through inferred goals and noise. In one embodiment, a method includes training a multi-modal model to generate a policy using semi-labeled data derived from wild data, and the multi-modal model predicts operator intent and a parameter associated with the policy for an agent in motion. The method also includes expanding outputs from the multi-modal model using noise within a diffusion model, and the noise augmenting the semi-labeled data. The method also includes feeding the outputs including the noise and the wild data to the multi-modal model until satisfying a training parameter associated with the policy.

### TECHNICAL FIELD

The subject matter described herein relates, in general, to a model estimating a policy for object motion, and, more particularly, to estimating the policy for the object motion by a prediction system training a multi-modal model through inferred goals and noise.

### BACKGROUND

A machine learning (ML) model can train to perform different tasks using data. For example, a ML model trains to accurately predict future outcomes using historical data about airline delays. Here, training can involve the ML model learning from labeling data for identifying patterns and relationships among a vast dataset. Furthermore, the ML model can also train to generate unique outputs through understanding the underlying distribution of training data. This allows the ML model to generate synthetic outputs that closely resemble the training data upon demand. For instance, a generative adversarial network creates realistic text and images for a product design. In this way, generative learning outputs new data points from learned distributions.

In various implementations, a ML model predicting outcomes and generating content when humans interact with automated machines encounters increased costs and complications. For instance, training certain models involves an operator inputting detailed control data and judging the accuracy of generated content. Costs with this approach quickly increase when the inputs involve different data modalities (e.g., text, audio, images, etc.) from various sources. Furthermore, complexity for training the ML model increases when factoring parameters from multiple agents (e.g., vehicles) that impacts the accuracy and relevance of the generated content. Therefore, systems building and training models to accomplish tasks involving an operator and a ML model face elevated costs and complexities.

### SUMMARY

In one embodiment, example systems and methods relate to estimating a policy for object motion by training a multi-modal model using diffusion through inferred goals and noise. In various implementations, a system generates content using a ML model that follows a policy, goal, etc., set by an operator when jointly interacting with an automated machine. For example, reinforcement learning involves an operator (e.g., a driver) and the ML model assisting each other for an agent (e.g., a vehicle) to complete a generative task. Here, the ML model training for the agent involves decision-making during actions in an environment that maximizes cumulative rewards. Shaping rewards through feedback can involve supervision for multi-modal systems, thereby increasing training costs and delays. Thus, a system training a ML model to execute a generative task involving joint interactions with an operator can be hindered by cost and training data that is limited.

Therefore, in one embodiment, a prediction system trains a multi-modal model for outputting a policy involving a joint operator and a learning model interacting together associated with a moving object using a diffusion model. Here, diffusion can involve outputting new data by transforming noise into coherent data. For example, the diffusion model has a noisifier function that injects noise (e.g., gaussian noise) into sparse data about object motion and refines the noisy data until attaining a completed output during training. The prediction system avoids certain drawbacks of reinforcement learning and other training approaches through training a multi-modal model to generate the policy using semi-labeled data and the diffusion model. In one approach, the diffusion model augments outputs and the semi-labeled data from the multi-modal model using noise. This allows the prediction system to fill missing data and diversify existing data for training the multi-modal model, thereby increasing reliability during implementation. Furthermore, training may continue until feeding the outputs including the noise to satisfy a training parameter associated with the policy. For example, the training parameter minimizes prediction losses while maintaining safety thresholds for motion. Accordingly, the prediction system efficiently trains the multi-modal model for estimating a policy involving joint interactions between an operator and a learning model through diffusion.

In one embodiment, a prediction system that estimates a policy for object motion by training a multi-modal model using diffusion through inferred goals and noise is disclosed. The prediction system includes a memory storing instructions that, when executed by a processor, cause the processor to train a multi-modal model to generate a policy using semi-labeled data derived from wild data, and the multi-modal model predicts operator intent and a parameter associated with the policy for an agent in motion. The instructions also include instructions to expand outputs from the multi-modal model using noise within a diffusion model, and the noise augments the semi-labeled data. The instructions also include instructions to feed the outputs including the noise and the wild data to the multi-modal model until satisfying a training parameter associated with the policy.

In one embodiment, a non-transitory computer-readable medium that estimates a policy for object motion by training a multi-modal model using diffusion through inferred goals and noise and including instructions that when executed by a processor cause the processor to perform one or more functions is disclosed. The instructions include instructions to train a multi-modal model to generate a policy using semi-labeled data derived from wild data, and the multi-modal model predicts operator intent and a parameter associated with the policy for an agent in motion. The instructions also include instructions to expand outputs from the multi-modal model using noise within a diffusion model, and the noise augments the semi-labeled data. The instructions also include instructions to feed the outputs including the noise and the wild data to the multi-modal model until satisfying a training parameter associated with the policy.

In one embodiment, a method for estimating a policy for object motion by training a multi-modal model using diffusion through inferred goals and noise is disclosed. In one embodiment, the method includes training a multi-modal model to generate a policy using semi-labeled data derived from wild data, and the multi-modal model predicts operator intent and a parameter associated with the policy for an agent in motion. The method also includes expanding outputs from the multi-modal model using noise within a diffusion model, and the noise augmenting the semi-labeled data. The method also includes feeding the outputs including the noise and the wild data to the multi-modal model until satisfying a training parameter associated with the policy.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a prediction system that is associated with estimating a policy for object motion by training a multi-modal model using diffusion through inferred goals and noise.

FIGS. 2A and 2B illustrate embodiments of the prediction system training and implementing a multi-modal model for estimating a policy involving joint-interactions.

FIG. 3 illustrates one example of generating a policy for vehicle motion in a driving environment involving joint control between an operator and a learning model.

FIG. 4 illustrates one embodiment of a method that is associated with training a multi-modal model to generate a policy using semi-labeled data and data diffusion.

### DETAILED DESCRIPTION

Systems, methods, and other embodiments associated with estimating a policy for object motion by training a multi-modal model using diffusion through inferred goals and noise are disclosed herein. In various implementations, policies generated through data diffusion generalize a planning setting for a task involving a single-agent. For example, a learning model estimating a path for an automated vehicle uses outputs from a diffusion function to complete missing data involving the path. Attempts for incorporating diffusion policies involving multi-agent tasks (e.g., operator-robot coordination) can be limited. This can be especially challenging for deriving interpretability about task-related outputs from a model, thereby impacting task reliability. Furthermore, diffusion policies can lack knowledge about operator criteria that hinder applications to operator-robot systems. Approaches applying reinforcement learning (RL) for tasks involving an operator and a learning model can demand domain knowledge regarding rewards, thereby limiting training robustness and model interpretability. Thus, systems generating a policy through diffusion can be limited to single-agent tasks, lack interpretability, and face difficulties when utilizing RL.

Therefore, in one embodiment, a prediction system has a multi-modal model that learns about discrete elements within a real environment and reasons about the elements for identifying operator inclinations and motivations involving an action with a learning model. In particular, the multi-modal model may train to generate a policy (e.g., a driving policy) using semi-labeled data including inferred states and goals for controlling a moving object. This allows the prediction system to increase data generalization while synergizing strengths associated with RL and diffusion policies through training the multi-modal model to accurately generate a joint policy.

In one approach, the prediction system trains the multi-modal model to automatically and agnostically generate a goal associated with a policy where an operator and learning model interact using a diffusion model. Training can involve adding noise to expand outputs from the multi-modal model using a noisifier within the diffusion model for implementations within an environment having natural interference associated with the goal. For instance, human interactions cause the driving task and the natural interference when interacting with the learning model. The multi-modal model can remove the natural interference and learn a denoising function that mitigates gaps within the outputs and semi-labeled data during implementation. This approach also improves interpretability as the multi-modal model can output counterfactuals and reasoning during implementation through learning the denoising function.

In another approach, the multi-modal model learns to generate a policy without adding noise to the semi-labeled data. For instance, the training involves observing policy changes from the interference during a joint-interaction involving an operator and a learning model. In this way, the multi-modal can reliably estimate a policy while minimizing training costs and complexity from having incomplete training data.

In various implementations, the prediction system estimates a policy for trajectory planning within an environment during the implementation of the multi-modal model using vehicle states. Here, the multi-modal model can output reliable estimates including data for interpretability (e.g., counterfactuals, reasoning, etc.) using a learned denoising function. The multi-modal model does so even with the environment having factors missing from the wild data during training. As such, the diffusion model accurately trains the multi-modal data by learning a denoising function from semi-labeled and wild data. Furthermore, the prediction system can generate a path using a diffusion function associated with the policy and the trajectory planning. For example, the trajectory planning (e.g., velocity, orientation, etc.) is associated with shared control and interaction between a driver and a vehicle using an automated driving system (ADS). The diffusion function can interface with the operator to decide a driving goal by understanding reasoning associated with the goal and coordination between the operator and the ADS. Accordingly, the prediction system can reduce “handcrafting” (e.g., intuition, guesses, etc.) for a goal and develop the goal in a data-driven manner that is efficient while having interpretability.

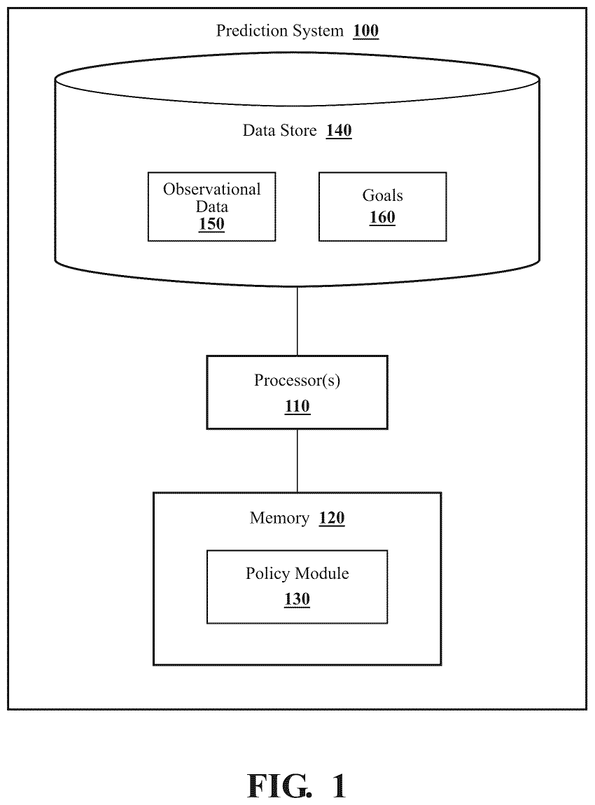

Referring to FIG. 1, one embodiment of a prediction system 100 that is associated with estimating a policy for object motion by training a multi-modal model using diffusion through inferred goals and noise is illustrated. For simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. The examples given may reference a joint-interaction between an operator and a learning model controlling an object, machine, robot, etc. together. Although certain examples reference a vehicle, the joint-interaction can involve an operator and any other automated device controlled by a learning model, a physical model (e.g., model predictive control), a data-driven model, etc. In either case, the prediction system 100 is implemented to perform methods and other functions as disclosed herein relating to estimating a policy for object motion by training a multi-modal model using a ML model through inferred goals and noise.

In one embodiment, the prediction system 100 includes a memory 120 that stores a policy module 130. The memory 120 is a random-access memory (RAM), a read-only memory (ROM), a hard-disk drive, a flash memory, or other suitable memory for storing the policy module 130. The policy module 130 is, for example, computer-readable instructions that when executed by the processor(s) 110 cause the processor(s) 110 to perform the various functions disclosed herein.

The prediction system 100 can generally be an abstracted form. Furthermore, the policy module 130 may generally include instructions that function to control the processor(s) 110 to receive data inputs. For instance, the data inputs are from one or more sensors of a vehicle. The inputs are, in one embodiment, observations of one or more objects in an environment proximate to the vehicle and/or other aspects about the surroundings. For instance, the policy module 130 acquires sensor data includes at least camera images that is stored as observational data 150. In further arrangements, the policy module 130 acquires the observational data 150 from further sensors such as radar sensors, LIDAR sensors, and other sensors as may be suitable for identifying objects, vehicles, locations of the vehicles, etc.

Moreover, in one embodiment, the prediction system 100 includes a data store 140. In one embodiment, the data store 140 is a database. The database is, in one embodiment, an electronic data structure stored in the memory 120 or another data store and that is configured with routines that can be executed by the processor(s) 110 for analyzing stored data, providing stored data, organizing stored data, and so on. Thus, in one embodiment, the data store 140 stores data used by the policy module 130 in executing various functions. In one embodiment, the data store 140 includes the observational data 150 and goals 160. The observational data 150 can include wild data, semi-labeled data, unstructured data, etc., associated with an operational environment for a learning model. The goals 160 can factor when generating a policy by a multi-modal model associated with a completing task involving an operator interacting with a learning model. For instance, the goals 160 include a vehicle operator using assisted driving to overtake another vehicle that is traveling below a speed limit. As further explained below, this goal can be different than an automated driving system that has a preference to remain behind and follow the other vehicle for safety. As such, the prediction system 100 can train the multi-modal model to generate an accurate policy that harmonizes the goals 160 involving the operator and the learning model automating a system for joint-interactions.

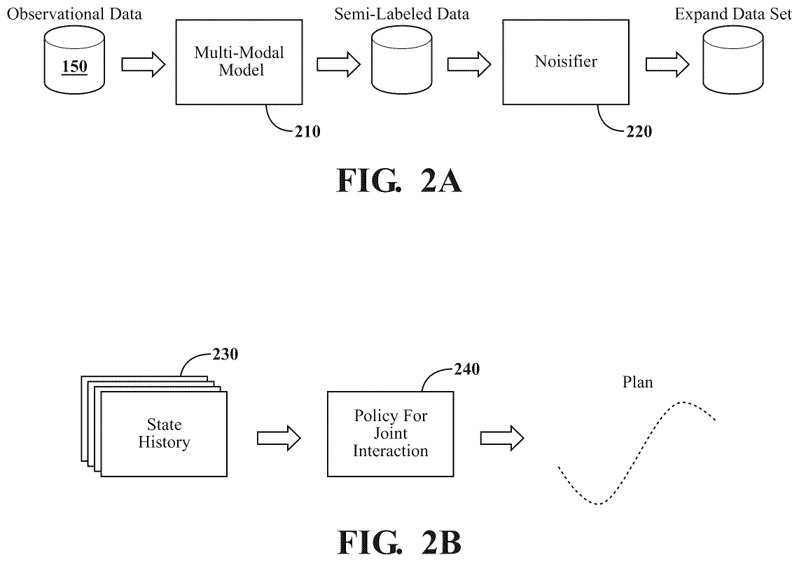

Now turning to FIGS. 2A and 2B, embodiments of the prediction system 100 training and implementing a multi-modal model for estimating a policy involving joint-interactions between an operator and a learning model are illustrated. In one embodiment, the prediction system 100 includes instructions that cause the processor(s) 110 to train a multi-modal model 210 to generate a policy using semi-labeled data, and the multi-modal model 210 predicts operator intent and a parameter associated with the policy for an agent in motion. For instance, the multi-modal model 210 is an inference model for estimating goals associated with the operator interacting with the learning model.

The multi-modal model 210 can derive the semi-labeled data from wild data forming the observational data 150 during training. For example, the multi-modal model 210 is a neural network that predicts classifications of objects within an environment through extracting and identifying salient features within the observational data 150 about goals of an operator and a learning model controlling a robot. In this way, the multi-modal model 210 can utilize the classifications for labeling during training and generate an upcoming policy for upcoming states (e.g., a vehicle crossing an intersection, a robot lifting a box, etc.) of the robot upon implementation.

In various implementations, the prediction system 100 can expand outputs from the multi-modal model 210 using noise within a diffusion model such that the noise augments the semi-labeled data during training. Here, the diffusion model can include the noisifier 220 for expanding a dataset from semi-labeled data that includes inferred motion goals and states through injecting noise. For instance, the noisifier 220 adds motion variations that are slight variations on the semi-labeled data associated with a policy, goal, etc. (e.g., a trajectory plan for a robot) in data areas for expansion. The slight variations can grow the recognizable state space that improves policy predictions from the multi-modal model, thereby enhancing training performance and robustness. This also allows the multi-modal model 210 to utilize data that is goal-conditioned for generating a policy through actual and artificial labels using diffusion. In another implementation, the noisifier 220 diffuses noise among the semi-labeled data and learns a denoising function for deriving the expanded dataset.

In one approach, the prediction system 100 feeds the outputs including the noise and the wild data to the multi-modal model 210 until satisfying a training parameter associated with the policy while minimizing a difference between outputs and the expanded dataset. For example, the training parameter minimizes prediction losses while maintaining safety thresholds for motion (e.g., highway driving) as an objective by injecting noise into the semi-labeled data representing robot trajectories (e.g., vehicle trajectories) and motion goals. In another example, the training parameter minimizes a joint-movement on a robot controlled by an operator and a learning model. In one approach, a diffusing sequence continues until reasoning over possibilities so that the multi-modal model 210 can accurately generate a policy from wild, unstructured, etc., data. As such, the policy can accurately reflect inclinations for a joint-interaction involving an operator and a learning model controlling an object. In this way, the multi-modal model 210 learns to diffuse out a policy for motion (e.g., a vehicle trajectory) while accomplishing operator objectives, automated control objectives, etc., without costly training (e.g., RL) and demanding vast training data.

As explained below, the multi-modal model 210 can utilize a transformer-based architecture for generating a policy. Here, a transformer architecture computes predictions by processing input data through multiple layers of attention mechanisms. Attention allows weighing the relevance of different features among the input data. This allows identifying complex patterns and relationships in the data for predictions that are contextual. Furthermore, the multi-modal model 210 estimating a policy can involve training with goal-agnostic data through diffusion to infer both operator intent (e.g., in a driving scenario, overtaking another vehicle, etc.) and policy parameters by assuming that a final state is the goal. Multi-modality allows for inputting operator intent and predictions from a learning model and forming a joint policy accordingly. For instance, a multi-modal driving scenario involves a preference to remain behind a neighboring vehicle by a learning model controlling a subject vehicle and the multi-modal model 210 supports the operator intent of overtaking the neighboring vehicle at the current time. As such, the prediction system 100 can use a transformer architecture to learn the relationship between states, goals, operator actions, and vehicle control. A diffusion model translates outputs from the transformer architecture into policy plans, mapping from the transformer into a proposed trajectory.

Regarding details about training the multi-modal model 210, the prediction system 100 may output semi-labeled data through observations for discrete modes from the observational data 150. Here, the observational data 150 can be unstructured data having data points that are sparse and gaps that the prediction system 100 supplements through diffusion for training. For instance, the semi-labeled data can be semantic labels for organizing and interpreting data using tags, classifications, categories, etc., assigned to a data point by inferring context about object states and goals for motion. A degree and an amount of the semi-labeled data can vary. As such, the training can involve minimal semi-supervision that relies upon minimal labeled and unlabeled data and supervised learning where a majority of the data is labeled. In this way, the prediction system 100 and the multi-modal model 210 can identify the semi-labeled data from the wild data that is unbalanced and sparse using one of supervision and semi-supervision for training.

Moreover, in one approach, a diffusion model utilizes the noisifier 220 to artificially label and expand the semi-labeled data post-hoc. Here, a one-to-one correspondence can exist between semantic labels and diffusion modes when the discrete modes are constrained as topologically distinct. A mode can be a forward diffusion process where the noisifier 220 adds noise to the semi-labeled for expansion. This fills gaps within sparsely populated areas of the semi-labeled data. Another mode can be a reverse diffusion process for denoising the expanded dataset upon injecting noise, thereby learning a denoising function.

During training, the multi-modal model 210 and the diffusion model can also complete semi-labeled data to satisfy a policy without operator feedback through reasoning over multiple possibilities for a driving task involving a vehicle. The labeled data can be semantic labels identifying different modes (e.g., images, sounds, etc.) from the wild data and the different modes include the operator intent. Furthermore, inputs to the multi-modal model may include a driving command and an automated maneuver. In one approach, the driving command is one of a braking command, an acceleration command, a steering command, a steering angle, a steering rotation, and the automated maneuver is the agent following a vehicle. Furthermore, the operator intent can be the agent overtaking a vehicle in a same travel lane that is different than the policy. A parameter for the policy can represent a goal of automatically following the vehicle.

In another approach, the prediction system 100 defines parameters for the noisifier 220 adding noise to a signal (e.g., an upcoming trajectory plan) for learning a denoising function. This allows the multi-modal model 210 to accurately generate a policy within an environment exhibiting natural noise. For example, the noise is produced from samples of possible interactions and demonstrations with humans and the learning model computes predictions from distinct features captured by the observation data 150. In this way, the multi-modal model 210 accurately and robustly learns from noise that is natural.

The prediction system 100 can remove noise for learning a denoising function through multiple iterations during training of the multi-modal model 210. The iterations can continue until satisfying a training parameter. The prediction system 100 adding noise during training allows implementing the multi-modal model 210 within an environment having natural interference for predicting a goal associated with a driving task. The natural interference can be associated with human interactions with the learning model. Learning the denoising function during training can have the multi-modal model 210 remove the natural interference when generating a policy during implementation.

In another embodiment, the multi-modal model 210 learns to generate a policy without adding noise to the semi-labeled data that includes inferred motion goals and states. For instance, the training involves observing policy changes from external interference during a joint-interaction involving an operator and a learning model. In this way, the prediction system 100 trains the multi-modal model 210 to operate in an environment with natural noise, thereby allowing increasingly intelligent and natural operation when generating a policy for interactive plans involving the operator and the learning model.

Referring to FIG. 2B, the prediction system 100 can estimate a policy 240 for joint interaction (e.g., trajectory planning) within an environment during implementation of the multi-modal model 210 using state history 230 representing multi-modal inputs. For example, the policy 240 projects future states to satisfy using the previous states derived from the state history 230. A joint-interaction between an operator and learning model controlling a robot (e.g., a vehicle) can be captured from the state history 230. In one approach, the environment can have factors missing from the wild data and the state history 230 describes vehicle states recently observed by a vehicle. For instance, the state history 230 includes that within a multi-agent (e.g., multiple vehicles, mixed vehicle and human, etc.) environments a vehicle overtook another vehicle on a highway while the vehicle stayed behind the vehicle near an intersection during stop-go traffic.

The prediction system 100 can form the policy 240 through a diffusion function such that the policy 240 exhibits complete paths for trajectory planning (e.g., velocity, orientation, etc.) consistent with the state history 230 even when training with data having gaps and imbalances. In one approach, the diffusion function denoises the state history 230 using the denoising function learned for the multi-modal model 210 during training. Denoising can remove natural noise, unusual noise, atypical noise, etc., originating from an operating environment and operator inputs (e.g., hand jitter). In this way, the diffusion function denoising improves accuracy and robustness when the multi-modal model generates a policy during a joint-interaction between an operator and a learning model controlling a robot.

Furthermore, the policy 240 can account for interactions between an operator and the vehicle involving a learning model. The policy 240 may apply for a time period, event (e.g., a vehicle trip), etc., and updated thereafter through iterations for aligning with inferred expectations associated with a joint-interaction. In this way, the multi-modal model 210 trained with diffusion can infer an operator goal and generate a plan (e.g., a vehicle trajectory) to satisfy an operator objective using a policy for the interactions. For example, the learning model generates a path from a trajectory plan using a goal and policy generated by the multi-modal model 210. The trajectory planning can be associated with shared control between a driver and the agent that is a vehicle using an ADS that includes the learning model.

In another implementation, an operator forms a trajectory plan for a robot using a receding-horizon controller, a MPC-based planner, a shared-decision model (SDM), etc., from an interactive policy. As previously explained, the multi-modal model 210 can generate a policy for an interaction between an operator and the agent associated with shared automation using a transformer-based architecture. The agent can be a vehicle, robot, etc., and a learning model that is data-driven using the transformer-based architecture. This allows a generative approach to SDM and generalization to new, unseen, etc., environments during training. As such, the prediction system 100 offers the benefit of greater generalization and synergizing the strengths of RL with diffusion models.

Concerning model interpretability, the prediction system 100 training the multi-modal model using diffusion allows presenting policy outputs including counterfactuals when an operator controls a machine with a learning model. Interpretability in machine learning allows an observer to understand how a model computes predictions in human-understandable terms, thereby improving system trust and transparency. For example, the prediction system 100 implemented in a vehicle presents a trajectory plan and related counterfactuals involving different paths to an operator for reasoning about different modes (e.g., a braking command, an automated maneuver, etc.) on a heads-up display, a console display, etc. The counterfactuals explain predictions from the multi-modal model 210 through hypothetical scenarios. For instance, the hypothetical scenarios increase interpretability by exhibiting how slight input changes produce different outcomes in computations. As previously explained, slight variations can increase the recognizable state space for policy predictions from the multi-modal model, thereby improving training performance and robustness.

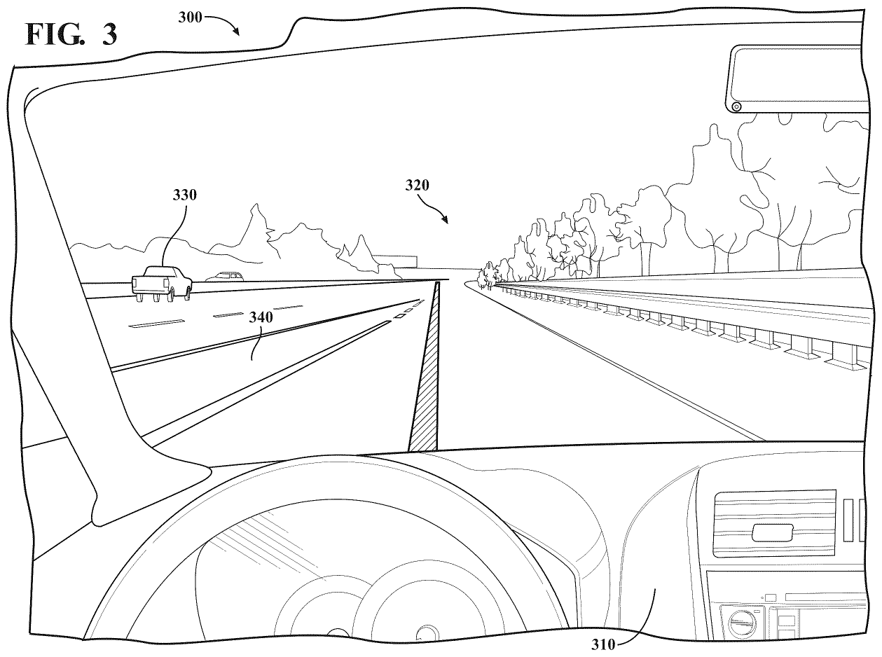

Regarding FIG. 3, one example of generating a policy for vehicle motion 300 in a driving environment involving joint control between an operator and a learning model is illustrated. Here, a vehicle 310 is traveling in a driving environment 320 having a pick-up truck 330. A SDM implements an ADS that shares control of the vehicle 310 with an operator using a learning model. While merging past road boundaries 340, the operator inputs acceleration and steering commands indicating crossing across multiple lanes about a speed limit and cutting ahead of the pick-up truck 330. Meanwhile, the ADS and the learning model indicate merging into the road without crossing the multiple lanes and cutting in front of the pick-up truck 330 and traveling below the speed limit.

For generating a policy involving joint interaction, the prediction system 100 estimates the policy for trajectory planning within the driving environment 320 using a multi-modal model processing vehicle states. The prediction system 100 accurately forms the policy even though the driving environment 320 has factors missing from the wild data. The SDM and the ADS generate a path associated with the policy and the trajectory planning. Accordingly, the prediction system 100 efficiently develops the policy and a driving goal in a data-driven manner through data diffusion while training the multi-modal model.

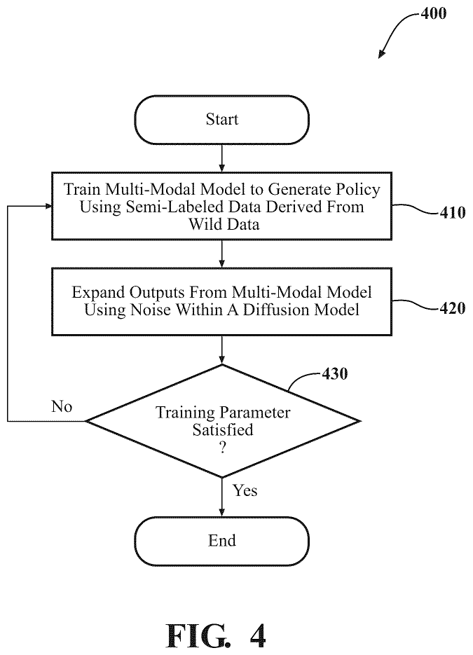

Turning to FIG. 4, a flowchart of a method 400 that is associated with training a multi-modal model to generate a policy using semi-labeled data and data diffusion is illustrated. Method 400 will be discussed from the perspective of the prediction system 100 of FIG. 1. While the method 400 is discussed in combination with the prediction system 100, it should be appreciated that the method 400 is not limited to being implemented within the prediction system 100 but is instead one example of a system that may implement the method 400.

At 410, the prediction system 100 and the policy module 130 train a multi-modal model to generate a policy using semi-labeled data derived from the observational data 150 having wild data. The multi-modal model can generate and impute a policy for shared autonomy between an operator and a learning model that together control a robot (e.g., a vehicle). Furthermore, labeling can identify desires of an operator along shared interactivity with the motion commands outputted from the learning model.

In various implementations, the multi-modal model derives the semi-labeled data from wild data forming the observational data 150. As previously explained, the multi-modal model can be a neural network that predicts classifications of objects within an environment through extracting and identifying salient features within the observational data 150. The features can be associated with goals of an operator and a learning model controlling a robot. In this way, the multi-modal model 210 can utilize the classifications for labeling that improves training and accurately generating a policy for upcoming states of the robot upon implementation.

In another approach, the prediction system 100 outputs semi-labeled data that includes inferred motion goals and states through observations for discrete modes from the observational data 150. For instance, the observational data 150 is unstructured and sparse data having gaps that the prediction system 100 supplements through diffusion for training. The semi-labeled data can be semantic labels for organizing and interpreting data using tags, classifications, categories, etc., assigned to a data point by inferring context. As such, the training involves semi-supervision that relies upon minimally labeled and unlabeled data and supervised learning where a majority of the data is labeled. In this way, the prediction system 100 can identify the semi-labeled data from data that is unbalanced and sparse using one of supervision and semi-supervision for training.

At 420, the prediction system 100 expands outputs from the multi-modal model using noise within a diffusion model until satisfying a training parameter at 430. In one approach, the diffusion model utilizes the noisifier 220 to artificially label and expand the semi-labeled data. Here, the diffusion model can learn a denoising function by filling gaps within sparsely populated areas of the semi-labeled data. For instance, a reverse diffusion process involves learning the denoising function from the expanded dataset upon injecting noise by observing the impact of various interference types to policy predictions.

In one approach, the prediction system 100 feeds noise-injected data to the multi-modal model until satisfying a training parameter associated with the policy. The training parameter can be associated with minimizing a difference between outputs of the multi-modal model and the expanded dataset. For instance, the training parameter minimizes prediction losses while maintaining safety thresholds for motion as an objective by injecting noise into the semi-labeled data. In another example, the training parameter minimizes a joint-movement on a robot controlled by an operator and a learning model. As such, a diffusing sequence continues until reasoning over possibilities so that the multi-modal model 210 can accurately generate a policy from wild, unstructured, etc., data. In this way, the policy accurately reflects inclinations and desires for a joint-interaction involving an operator and a learning model controlling an object.

In another approach, the prediction system 100 defines operation of a noisifier when adding noise to a signal (e.g., an upcoming trajectory plan) so that the multi-modal model accurately generates a policy within an environment exhibiting natural noise. Here, the noise can be produced from samples of possible interactions and demonstrations with humans and the learning model identifies distinct features from the observation data 150. As previously explained, this noise can be removed for learning a denoising function through multiple iterations during training of the multi-modal model until satisfying a training parameter. As such, the prediction system 100 adds noise during training and learns a denoising function for implementing the multi-modal model within an environment having natural interference for a goal associated with a driving task. The natural interference is associated with human interactions and learning the denoising function during training can have the multi-modal model reliably remove the natural interference when generating a policy during implementation. Accordingly, the prediction system 100 trains the multi-modal model to generate a policy for motion (e.g., a vehicle trajectory) through diffusion while accomplishing operator goals, automated control goals, etc., without costly training (e.g., RL) and demanding vast training data.

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A prediction system comprising:
a memory storing instructions that, when executed by a processor, cause the processor to:
train a multi-modal model to generate a policy using semi-labeled data derived from wild data, and the multi-modal model predicts operator intent and a parameter associated with the policy for an agent in motion;
expand outputs from the multi-modal model using noise within a diffusion model, and the noise augments the semi-labeled data; and
feed the outputs including the noise and the wild data to the multi-modal model until satisfying a training parameter associated with the policy.

2. The prediction system of claim 1 further including instructions to:
estimate the policy for trajectory planning within an environment during implementation of the multi-modal model using a diffusion function with vehicle states, the environment having factors missing from the wild data; and
generate a path with the policy and the trajectory planning;
wherein the trajectory planning is associated with shared control between a driver and the agent that is a vehicle using an automated driving system (ADS).

3. The prediction system of claim 1 further including instructions to:
add the noise using a noisifier for implementing the multi-modal model within an environment having natural interference for a goal associated with a driving task, and the natural interference is associated with human interactions; and
learn a denoising function to remove the natural interference by the multi-modal model.

4. The prediction system of claim 3 further including instructions to:
complete the outputs by the multi-modal model using the denoising function to satisfy the policy without operator feedback, wherein the outputs reason over multiple possibilities for a driving task.

5. The prediction system of claim 1 further including instructions to:
identify the semi-labeled data from the wild data using one of supervision and semi-supervision, wherein the wild data is unbalanced and sparse.

6. The prediction system of claim 1, wherein:
the labeled data are semantic labels identifying different modes from the wild data and the different modes include the operator intent; and
the semantic labels and the different modes are topologically constrained and include a one-to-one correspondence between the semantic labels and the different modes.

7. The prediction system of claim 1, wherein:
inputs to the multi-modal model include a driving command and an automated maneuver, the driving command is one of a braking command, an acceleration command, and a steering command, and the automated maneuver is the agent following a vehicle; and
the operator intent is the agent overtaking a vehicle in a same travel lane and the parameter represents automatically following the vehicle.

8. The prediction system of claim 1, wherein the multi-modal model is a shared-decision model (SDM) for driving that uses a transformer-based architecture, and the multi-modal model generates the policy for an interaction between an operator and the agent associated with shared automation.

9. A non-transitory computer-readable medium comprising:
instructions that when executed by a processor cause the processor to:
train a multi-modal model to generate a policy using semi-labeled data derived from wild data, and the multi-modal model predicts operator intent and a parameter associated with the policy for an agent in motion;
expand outputs from the multi-modal model using noise within a diffusion model, and the noise augments the semi-labeled data; and
feed the outputs including the noise and the wild data to the multi-modal model until satisfying a training parameter associated with the policy.

10. The non-transitory computer-readable medium of claim 9 further including instructions to:
estimate the policy for trajectory planning within an environment during implementation of the multi-modal model using a diffusion function from vehicle states, the environment having factors missing from the wild data; and
generate a path with the policy and the trajectory planning;
wherein the trajectory planning is associated with shared control between a driver and the agent that is a vehicle using an automated driving system (ADS).

11. The non-transitory computer-readable medium of claim 9 further including instructions to:
add the noise using a noisifier for implementing the multi-modal model within an environment having natural interference for a goal associated with a driving task, and the natural interference is associated with human interactions; and
learn a denoising function to remove the natural interference by the multi-modal model.

12. The non-transitory computer-readable medium of claim 11 further including instructions to:
complete the outputs by the multi-modal model using the denoising function to satisfy the policy without operator feedback, wherein the outputs reason over multiple possibilities for a driving task.

13. A method comprising:
training a multi-modal model to generate a policy using semi-labeled data derived from wild data, and the multi-modal model predicts operator intent and a parameter associated with the policy for an agent in motion;
expanding outputs from the multi-modal model using noise within a diffusion model, and the noise augmenting the semi-labeled data; and
feeding the outputs including the noise and the wild data to the multi-modal model until satisfying a training parameter associated with the policy.

14. The method of claim 13 further comprising:
estimating the policy for trajectory planning within an environment during implementation of the multi-modal model using a diffusion function with vehicle states, the environment having factors missing from the wild data; and
generating a path with the policy and the trajectory planning;
wherein the trajectory planning is associated with shared control between a driver and the agent that is a vehicle using an automated driving system (ADS).

15. The method of claim 13 further comprising:
adding the noise using a noisifier for implementing the multi-modal model within an environment having natural interference for a goal associated with a driving task, and the natural interference associated with human interactions; and
learning a denoising function to remove the natural interference by the multi-modal model.

16. The method of claim 15 further comprising:
completing the outputs by the multi-modal model using the denoising function to satisfy the policy without operator feedback, wherein the outputs reason over multiple possibilities for a driving task.

17. The method of claim 13 further comprising:
identifying the semi-labeled data from the wild data using one of supervision and semi-supervision, wherein the wild data is unbalanced and sparse.

18. The method of claim 13, wherein:
the labeled data are semantic labels identifying different modes from the wild data and the different modes include the operator intent; and
the semantic labels and the different modes are topologically constrained and include a one-to-one correspondence between the semantic labels and the different modes.

19. The method of claim 13, wherein:
inputs to the multi-modal model include a driving command and an automated maneuver, the driving command is one of a braking command, an acceleration command, and a steering command, and the automated maneuver is the agent following a vehicle; and
the operator intent is the agent overtaking a vehicle in a same travel lane and the parameter represents automatically following the vehicle.

20. The method of claim 13, wherein the multi-modal model is a shared-decision model (SDM) for driving that uses a transformer-based architecture, and the multi-modal model generates the policy for an interaction between an operator and the agent associated with shared automation.
